(19) United States
(12) Patent Application Publication
(10) Pub. No.: US 2019/0139519 A1
(43) Pub. Date: May 9, 2019

(54) Dynamic Drum Beater

(71) Applicant: Richard L. Farago, Westford, MA (US)

(72) Inventor: Richard L. Farago, Westford, MA (US)

(21) Appl. No.: 16/202,122

(22) Filed: Nov. 28, 2018

Related U.S. Application Data
(63) Continuation of application No. 15/806,362, filed on Nov. 8, 2017, now abandoned.

(51) Int. Cl. G10D 13/00; G10D 13/02

(52) U.S. Cl. CPC G10D 13/006; G10D 13/00; G10D 13/02; G10D 13/003

(57) ABSTRACT

A drum beater shaft with a flexible coupling means disposed between the base portion of the shaft and the head portion of the shaft is disclosed. The base portion of the shaft is fixed in the user's hand. The head portion of the shaft contains a striking device used to contact the drum. In one preferred group of embodiments, the flexible coupling means disposed between the base portion and head portion of the drum beater shaft takes the form of a spring surrounded by an elastic sheath, a universal joint surrounded by an elastic sheath and a ball and socket joint surrounded by and elastic sheath. In yet another preferred group of embodiments, the flexible coupling means disposed between the base portion and head portion of the drum beater shaft takes the form of an elastomeric flexible coupling, a thermoplastic polyurethane element, a thermoplastic elastomer element, a thermoplastic urethane element, a thermoset elastomer element and a thermoset urethane element.

### PRIORITY

This application is a continuation in part and claims priority to U.S. Nonprovisional application Ser. No. 15/806,362 filed Nov. 8, 2017 which was a continuation and claims priority to U.S. Nonprovisional application Ser. No. 15/635,539 filed Jun. 28, 2017 which was a partial continuation and claims priority to U.S. Nonprovisional application Ser. No. 15/256,777 filed Sep. 6, 2016.

### BACKGROUND OF INVENTION

The present invention is directed to a dynamic drum beater. Bass drum beaters have felt, wood or plastic beaters and chrome, steel metal shafts. The dynamic drum beater is based on a conventional beater; however, differs drastically because it utilizes a spring and damper arrangement to aid the performer in striking the drum resulting in a lift in rebound which enhances the upstroke. Capitalizing on the energy of a spring to aid the performer and rebound off of the drum. The end of the beater (where it impacts the drum) uses a conventional felt, wood or plastic tip or essentially any material used to strike drums.

The prior art discloses a drum stick with a spring coupling between the handle portion and the impacting portion. The spring can be locked so as to make the handle and impacting portion of the stick fixed. The prior art further discloses a ball fitted to a compression spring actuated be electric current for use with a Xylophone. Also disclosed in the prior art, is a thimble device which fits over the fingers of the player of a Glockenspiel, or similar instrument, where a small metal spring projects from the end of the thimble to which a wooden button is attached. The prior art also makes known the use of a spring loaded base drum assembly where the spring works to return the drum stick and head away from the drum face when the foot pedal is released.

The present invention differs from the prior art in one preferred embodiment of the present invention which employs a spring between the hand-held portion of the beater shaft and the impact portion of the beater shaft with a damping cover means fitted over the spring to stiffen the assembly and provide the desired flexibility when used. In a second preferred embodiment of the present invention, a universal joint is employed between the hand-held portion of the beater shaft and the impact portion of the beater shaft with a spring cover means fitted over the universal joint to stiffen the assembly and provide the desired flexibility when used. In yet a third preferred embodiment of the present invention, a ball and socket joint is employed with a spring cover means fitted over the ball and socket joint to stiffen the assembly and provide the desired flexibility when used.

### BRIEF SUMMARY OF INVENTION

A dynamic drum beater comprising a shaft with a head portion and a base portion, the head portion of the shaft adapted to receive a drum striking attachment, the base portion of the shaft adapted to fit in an operator's hand, a flexible joint disposed between the head portion and base portion of the shaft to provide vibration of the drum striking attachment on the drum.

### DRAWINGS

FIG. 1 is an isometric view of a preferred embodiment of the present invention.

FIG. 2 is a cross section of a preferred embodiment of the present invention.

FIG. 3 is a cross section of a preferred embodiment of the present invention.

FIG. 3A is an isometric view of a preferred embodiment with the outer wrap removed.

FIG. 4 is a cross section of a preferred embodiment of the present invention.

FIG. 4A is an isometric view of a preferred embodiment with the outer wrap removed.

FIG. 5 is a cross section of a preferred embodiment of the present invention.

FIG. 5A is an isometric view of a preferred embodiment.

FIG. 6 is an isometric view of a preferred embodiment of the present invention.

FIG. 6A is a cross section of a preferred embodiment of the present invention.

FIG. 7 is an isometric view of a preferred embodiment of the present invention.

FIG. 7A is a cross section of a preferred embodiment of the present invention.

FIG. 8 is an isometric view of a preferred embodiment of the present invention in action in a user's hand.

### DETAILED DESCRIPTION OF INVENTION

The present invention will now be described in terms of the presently preferred embodiment thereof as illustrated in the drawings. Those of ordinary skill in the art will recognize that many obvious modifications may be made thereto without departing from the spirit or scope of the present invention.

The present invention is directed to address the short comings in an arrangement where a spring or other flexible joint is inserted between the fixed-end and the striking end of a drum stick. These arrangements provide the bounce back when the striking end of the drum stick comes in contact with the drum, but do not effectively control it. Specifically, the striking end of the drum stick—in the single spring configuration—bounces back in a non-linear and generally uncontrolled manner. This is especially true in the ball joint and universal joint embodiments when the outer elastic housing is not used.

One series of preferred embodiments of the present invention is directed to solve the uncontrolled and non-liner bounce back disclosed in the prior art by the use of an elastic sheath surrounding the joint in the drum stick. In this series of preferred embodiments, the elastic sheath surrounding the joint acts as a stiffener and damper (i.e., in the spring configuration); a stiffener, a spring and a damper (i.e., in the universal joint configuration) and a stiffener, a spring and a damper (i.e., in the ball joint configuration).

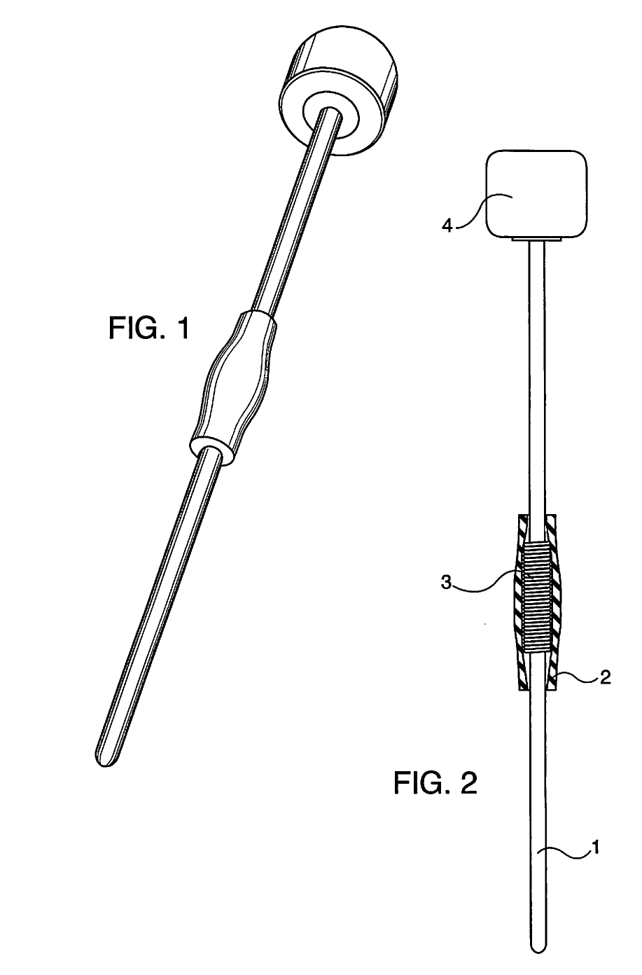

An isometric view of one preferred embodiment of the present invention is shown at FIG. 1. FIG. 1 depicts a typical bass drum beater device to be held in the hand of the user.

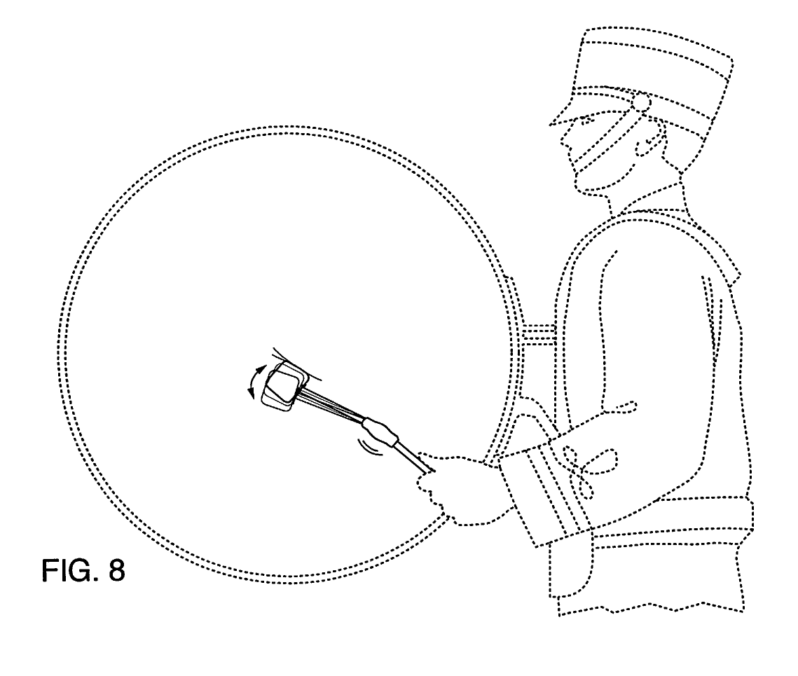

In a preferred embodiment of the present invention, a spring 3 is disposed at the head of shaft 1. FIG. 2. The base of the shaft 1 is held in the user's hand (FIG. 8). The drum beater device 4 could be any traditional beater device or material (e.g., felt, wood, composite, synthetic) typically used. The spring 3 is wrapped with an elastic sheath 2 to provide damping to the spring 3 and stiffness to the spring/elastic sheath assembly. FIG. 2. The elastic sheath 2 is made from an elastic material such as rubber, synthetic rubber or polymer. The operator of a typical bass drum would hold the base of shaft 1 and strike the bass drum with the drum beater device 4.

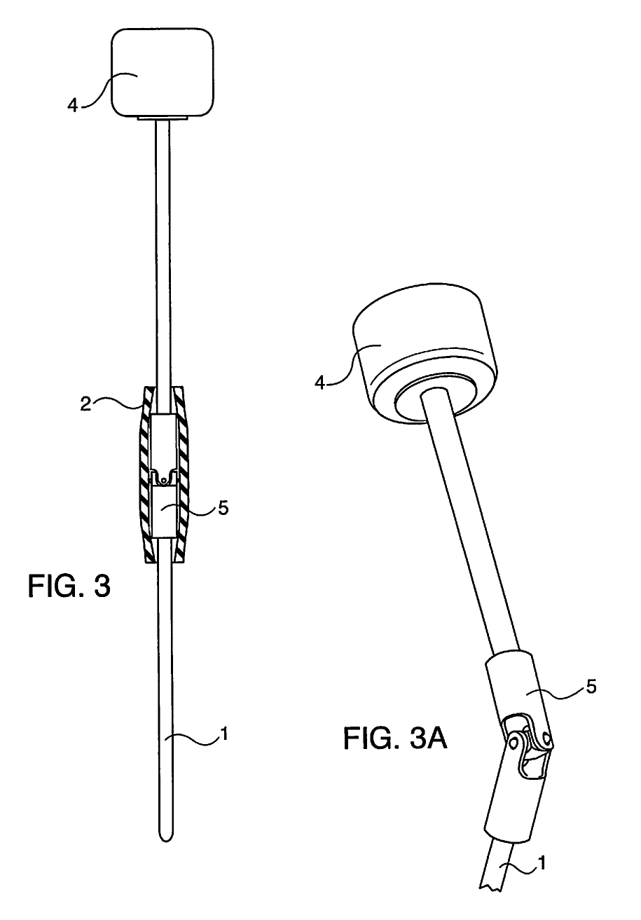

In another preferred embodiment of the present invention, a universal joint 5 is disposed in shaft 1. FIG. 3 and FIG. 3A. The base of the shaft 1 is held in the hand of the user (FIG. 8). A drum beater device 4 is affixed to the head of the shaft 1. The universal joint 5 is wrapped with an elastic sheath 2 to provide spring and damping to the universal joint 5 and stiffness to the universal joint/elastic sheath assembly. FIG. 3. The operator of a typical bass drum arrangement would hold the base of shaft 1 and strike the bass drum with the drum beater device 4.

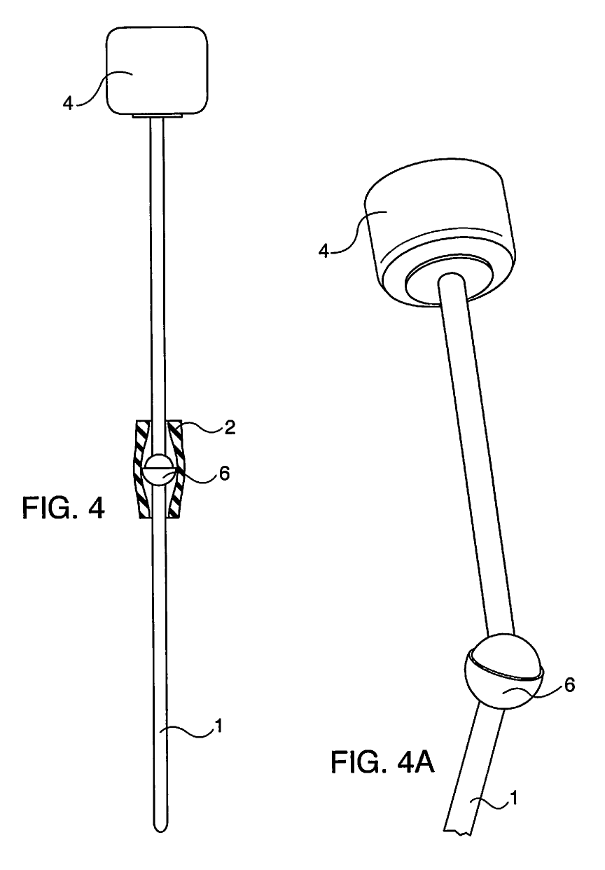

In yet another preferred embodiment of the present invention, a ball and socket joint 6 is disposed between the head and base of shaft 1. FIG. 4 and FIG. 4A. The base of the shaft 1 is held in the user's hand (FIG. 8). A drum beater device 4 is affixed to the head of shaft 1. The universal joint 6 is wrapped with an elastic sheath 2 to provide spring and damping to the ball and socket joint 6 and stiffness to the ball and socket/elastic sheath assembly. FIG. 4. The operator of a typical bass drum would hold the base end of shaft 1 and strike the bass drum with the drum beater device 4.

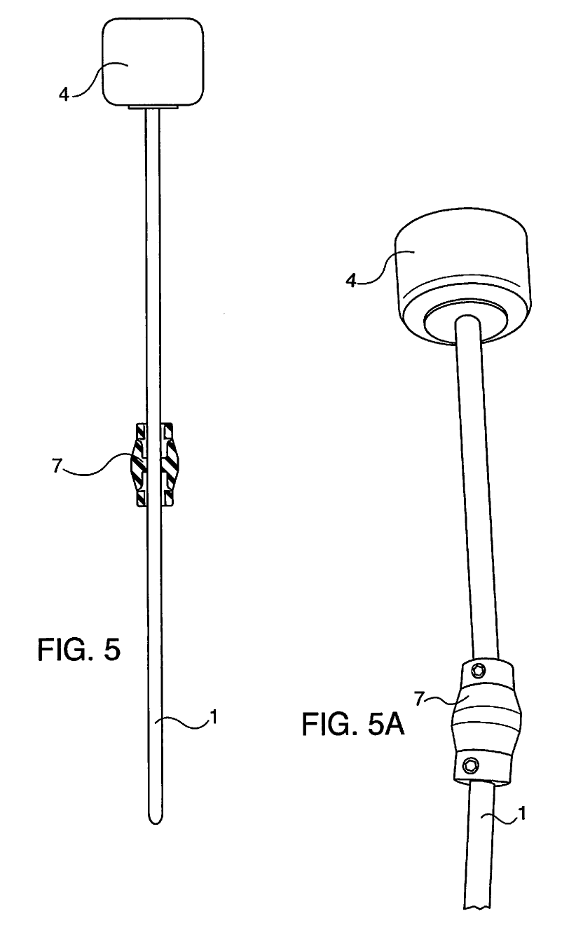

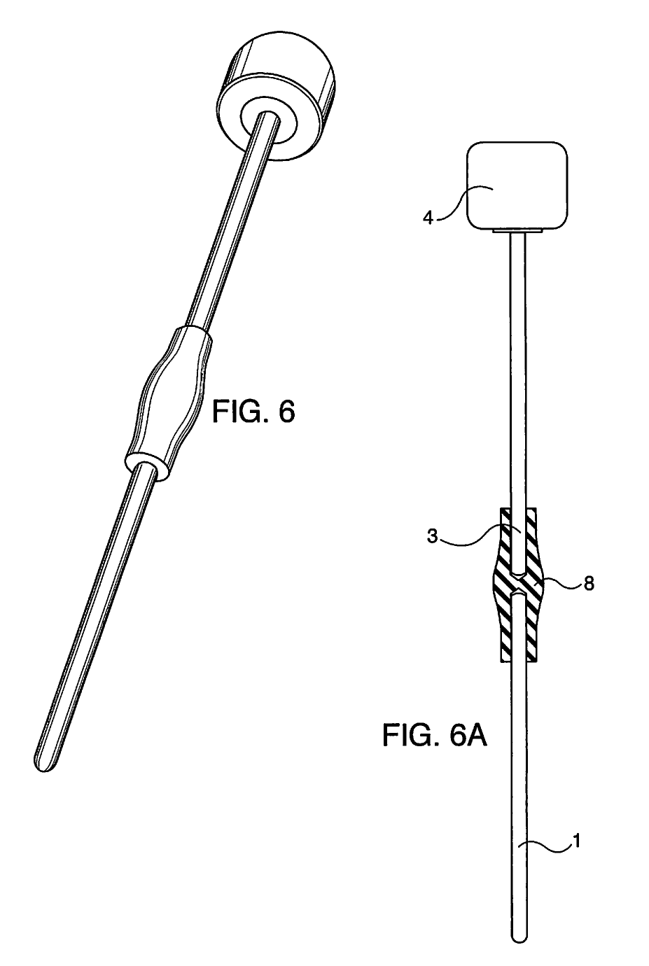

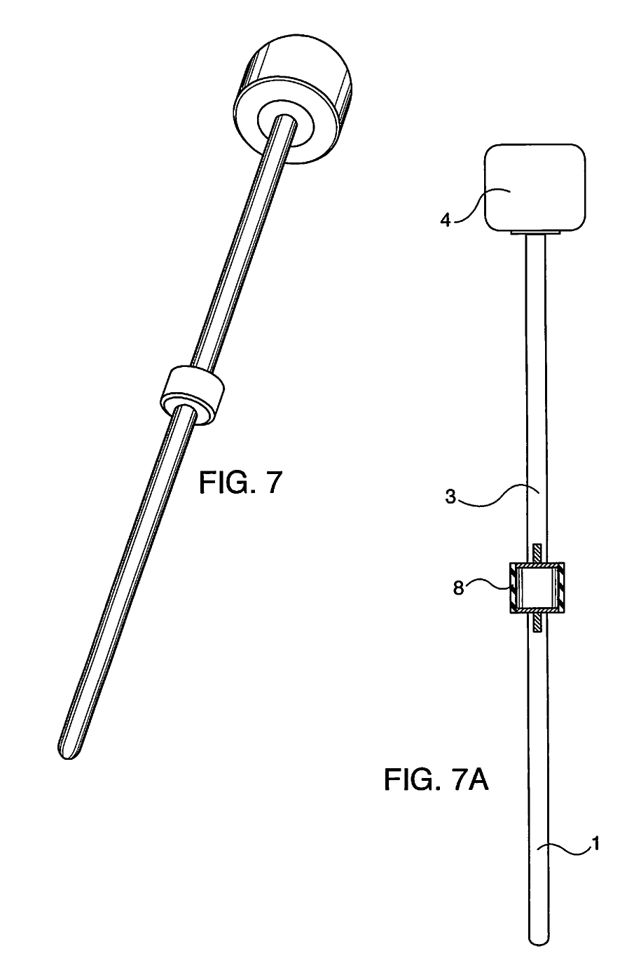

A second series of preferred embodiments of the present invention is directed to solve the uncontrolled and non-liner bounce back disclosed in the prior art by the use of an elastomeric flexible coupling material (FIG. 5, FIG. 5A and FIG. 8); a thermoplastic elastomer element; a thermoplastic urethane material (FIG. 7, FIG. 7A and FIG. 8) and thermoset elastomer element and a thermoset urethane element—each placed in between the two ends of a drum stick.

Thermoplastic elastomer elements, sometimes referred to as thermoplastic rubbers, are a class of copolymers or a physical mix of polymers (usually a plastic and a rubber) which consist of materials with both thermoplastic and elastomeric properties. While most elastomers are thermosets, thermoplastics are in contrast relatively easy to use in manufacturing, for example, by injection molding. Thermoplastic elastomers show advantages typical of both rubbery materials and plastic materials. The benefit of using thermoplastic elastomers is the ability to stretch to moderate elongations and return to its near original shape creating a longer life and better physical range than other materials. Specifically, thermoplastic polyurethane elements are thermoplastic elastomer elements consisting of linear segmented block copolymers composed of hard and soft segments.

Thermosets elastomer elements are defined by their very large deformability with essentially complete recoverability. For a material to exhibit such elasticity, it must consist of polymeric chains: these must ha c a high degree of flexibility and mobility and be joined into a network structure by cross-linking pairs of segments, thereby preventing stretched polymer chains from irreversibly sliding past one another. These elastomers are frequently included in the category of “thermosets,” which are polymers with a network structure that is generated or “set” by thermally induced chemical cross-linking reactions. The term often takes on the more specific meaning of networks that are very heavily crosslinked and below their glass transition temperatures. These are very hard materials with none of the high extensibility associated with typical elastomers. Specifically, a thermoset urethane is a polymer that originates as a soft solid or thick liquid prepolymer or resin. Curing changes the resin into an insoluble polymer network. Curing is induced by heat or by mixing with a catalyst. Often, the process involves molding into finished parts.

In this series of preferred embodiments, an elastomeric flexible coupling 7 is used like that manufactured by Dynaflex® in place of a spring wrapped in a rubber sheath to provide both vibration and damping. FIG. 5 and FIG. 5A. Alternatively, a thermoplastic polyurethane material 8 like that produced by NINJAFLEX is used in place of a spring wrapped in a rubber sheath to provide both vibration and damping. FIG. 7 and FIG. 7A.

The elastomeric flexible coupling 7 like that manufactured by Dynaflex® bore size is matched to the drum stick 1 shaft diameter. Set screws through the outer bores of the elastomeric flexible coupling work to connect the drum stick shafts to the coupling. FIG. 5 and FIG. 5A.

The thermoplastic polyurethane material 8 like that produced by NINJAFLEX is manufactured to create a transition element between two drum stick shafts 1 and 3 with internal bores sized to match the drum stick shafts diameter. FIG. 7 and FIG. 7A. Glue is used to connect the drum stick shafts 1 and 3 to the transition element.

At the moment of impact of the drum beater device 4 on the bass drum, the flexible joint arrangement of the present invention (FIG. 2, FIG. 3, FIG. 4, FIG. 5 and FIG. 7A) will provide an instantaneous flexion which results in an enhanced rebound of the drum beater device 4 off of the bass drum. The present invention utilizes the various flexible joint configurations of the present invention to achieve a more robust rebound which allows the musician to achieve an upstroke off of the bass drum with greater ease thereof reducing fatigue and the effort required to achieve full down, and upstrokes and all drum strokes is much less than compared to conventional drum beater arrangement as well as protecting the user's extremities from the force of impact caused by the striking drum.

The placement of the spring (3), universal joint (5), ball and socket joint (6), an elastomeric flexible coupling (7) and/or a thermoplastic polyurethane element (8) along the shaft 1 relative to the location of the drum beater device will provide more or less bounce of the drum beater device 4 against the bass drum. Specifically, on the hand-held drum stick, optimal performance of the flexible joint is obtained when the flexible joint is located between 25% to 59% of the shaft length as measured from the end point of the bottom of the drum stick. Here, again, the present invention allows the user to achieve a more natural rebound which allows the operator to achieve an upstroke off of the drum with greater ease.

Those of ordinary skill in the art will recognition that the embodiments just described merely illustrate the principals of the present invention. Many obvious modifications may be made thereto without deputing from the spirit or scope of the invention as set forth in the appended claims.

1. A dynamic drum beater comprising:
A shaft with a head portion and a base portion;
the head portion of the shaft adapted to receive a drum striking attachment;
the base portion of the shaft adapted to be held in a user's hand;
a flexible joint disposed between the head portion and base portion of the shaft to provide vibration of the drum striking attachment on a drum;
the flexible joint located between 25% to 59% of the shaft length measured from the end of the base portion of the shaft.

2. The dynamic drum beater of claim 1, wherein the flexible joint is spring covered with an elastic sheath.

3. The dynamic drum beater of claim 1, wherein the flexible joint is a universal joint covered with an elastic sheath.

4. The dynamic drum beater of claim 1, wherein the flexible joint is a ball and socket joint covered with an elastic sheath.

5. A method for striking a drum with a dynamic drum beater comprising:
A shaft with a head portion and a base portion; the head portion of the shaft adapted to receive a drum striking attachment; the base portion of the shaft adapted to be held in a user's hand; a flexible joint disposed between the head portion and base portion of the shaft to provide vibration of the drum striking attachment when the drum striking attachment comes into contact with a drum; the flexible joint located between 25% to 59% of the shaft length measured from the end of the base portion of the shaft.
holding the dynamic drum beater in the hand or hands of the user;
striking the drum with the drum striking attachment of the dynamic drum beater;
vibrating the drum striking attachment of the dynamic drum beater on the drum.

6. The method of claim 5, wherein the flexible joint is a spring covered with an elastic sheath.

7. The method of claim 5, wherein the flexible joint is a universal joint covered with an elastic sheath.

8. The method of claim 5, wherein the flexible joint is a ball and socket joint covered with an elastic sheath.

9. The dynamic drum beater of claim 1, wherein the flexible joint is an elastomeric flexible coupling.

10. The dynamic drum beater of claim 1, wherein the flexible joint is a thermoplastic polyurethane element.

11. The method of claim 5, wherein the flexible joint is an elastomeric flexible coupling.

12. The method of claim 5, wherein the flexible joint is a thermoplastic polyurethane element.

13. The dynamic drum beater of claim 1, wherein the flexible joint is a thermoplastic elastomer element.

14. The dynamic drum beater of claim 1, wherein the flexible joint is a thermoplastic urethane element.

15. The method of claim 5, wherein the flexible joint is a thermoplastic elastomer element.

16. The method of claim 5, wherein the flexible joint is a thermoplastic urethane element.

17. The dynamic drum beater of claim 1, wherein the flexible joint is a thermoset elastomer element.

18. The dynamic drum beater of claim 1, wherein the flexible joint is a thermoset urethane element.

19. The method of claim 5, wherein the flexible joint is a thermoset urethane element.
